(19) United States
(12) Patent Application Publication
(10) Pub. No.: US 2022/0076370 A1
(43) Pub. Date: Mar. 10, 2022

(54) IMAGE PROCESSING CONTROL APPARATUS AND IMAGE PROCESSING CONTROL METHOD

(71) Applicant: SONY GROUP CORPORATION, TOKYO (JP)

(72) Inventors: TAKURO KAWAI, TOKYO (JP); KENICHIRO HOSOKAWA, TOKYO (JP); YOSHIYUKI AKIYAMA, TOKYO (JP); SHUICHI TAKAHASHI, TOKYO (JP); TAKAFUMI MORIFUJI, TOKYO (JP)

(21) Appl. No.: 17/309,948

(22) PCT Filed: Nov. 8, 2019
(86) PCT No.: PCT/JP2019/043870

§ 371 Date: Jul. 2, 2021

(30) Foreign Application Priority Data
Jan. 17, 2019 (JP) 2019-005874

(51) Int. Cl. G06T 1/20; G06T 7/00

(52) U.S. Cl. CPC G06T 1/20; G06T 2200/24; G06T 2207/30168; G06T 7/0002

(57) ABSTRACT

The image processing control apparatus 20 acquires the processing performance of the image processing apparatuses 30-1 to 30-n, and causes the image processing apparatuses 30-1 to 30-n to process test images appropriate to their own processing performance. Furthermore, the image processing control apparatus 20 evaluates the image qualities of the processed test images, and selects, for each image processing to be performed on an input image, an image processing apparatus that generates a processed image with good image quality on the basis of the processing performance and image quality evaluation results of the image processing apparatuses 30-1 to 30-n. Thus, the image processing control apparatus 20 sets an optimum processing flow, and controls the image processing apparatuses on the basis of the optimum processing flow. Therefore, it is possible to allot a portion of image processing to each of a plurality of image processing apparatuses so that an output image with good image quality can be obtained.

### TECHNICAL FIELD

The present technology relates to an image processing control apparatus and an image processing control method, which enable a high-quality processed image to be obtained.

### BACKGROUND ART

Conventionally, a plurality of apparatuses is used for image processing on an input signal such that the apparatuses each perform an allotted portion of the image processing in collaboration with each other, so as to obtain a processing result with higher quality than in a case where the image processing is performed by a single apparatus. For example, Patent Document 1 discloses determining whether another apparatus is connected and changing the function of a signal processing means that processes an input signal depending on whether another apparatus is connected or not. Furthermore, Patent Document 2 discloses releasing a display device from some processing tasks to achieve an improvement in processing performance, by distributing audio and video processing tasks among a plurality of devices interconnected with the display device.

### CITATION LIST

### Patent Document

Patent Document 1: Japanese Patent Application Laid-Open No. 2002-374461

Patent Document 2: Japanese Patent No. 5689802

### SUMMARY OF THE INVENTION

### Problems to be Solved by the Invention

Incidentally, in a case where another apparatus connected to a predetermined image processing apparatus performs a portion of image processing allotted to the another apparatus, a load on the predetermined image processing apparatus is reduced. However, even if the portion of processing is allotted to the another apparatus according to the performance thereof, it is not always possible to obtain a high-quality processed image.

Therefore, the present technology provides an image processing control apparatus and an image processing control method capable of allotting a portion of image processing to each of a plurality of image processing apparatuses so that an output image with good image quality can be obtained.

### Solutions to Problems

A first aspect of the present technology is an image processing control apparatus including:

a processing flow setting unit that sets a processing flow for each set of multiple types of image processing to be performed on an input image, by selecting an image processing apparatus to be used for each of the multiple types of image processing on the basis of results of evaluating image qualities of processed images obtained from a test image processed by a plurality of image processing apparatuses.

In the present technology, a processing flow is set by selection of an image processing apparatus to be used for each of multiple types of image processing on the basis of results of evaluating image qualities of processed images obtained from a test image processed by a plurality of image processing apparatuses. The test image is an image generated as a result of performing, on an evaluation image, processing that is a reverse of each of the multiple types of image processing. Results of evaluating qualitative image qualities and quantitative image qualities of the processed images with respect to the evaluation image or evaluation results obtained by integration of the results of evaluating the qualitative image qualities and the quantitative image qualities are used as the image evaluation results. The processing flow setting unit of the image processing control apparatus selects, for example, an image processing apparatus that produces a best image quality evaluation result for each of the multiple types of image processing. In this case, an image to be used as the test image is obtained for each image processing apparatus as a result of the processing performed on an evaluation image appropriate to the processing performance of the image processing apparatus. Furthermore, for example, the processing flow setting unit sets a plurality of processing flows by changing combinations of respective image processing apparatuses to be used for the multiple types of image processing, and selects image processing apparatuses corresponding to a processing flow that produces a best result of evaluating an image quality of an output image that is obtained as a result of performing the multiple types of image processing on the input image. In this case, an image to be used as the test image is generated as a result of performing processing on the evaluation image, the processing being a reverse of the multiple types of image processing to be performed on the input image on the basis of the processing flow set in the processing flow setting unit. In addition, the processing flow setting unit may perform parameter adjustment for the respective image processing apparatuses to be used for the multiple types of image processing, and set parameters that produce a best result of evaluating the image quality of the output image, the output image being obtained as a result of performing the multiple types of image processing on the input image.

Furthermore, the image processing control apparatus may include an information storage unit that stores processing orders of the multiple types of image processing, information indicating image processing apparatuses selected for each of the processing orders, and the image quality evaluation results. Furthermore, there may be provided a processing performance management unit that detects an image processing apparatus available for image processing of the input image on the basis of processing performance of the image processing apparatus so that the processing flow setting unit can select an image processing apparatus to be used for the image processing from among a plurality of the image processing apparatuses detected in the processing performance management unit. Furthermore, the processing performance management unit detects a change in the image processing apparatuses available for the image processing of the input image, and in a case where there is a change in the available image processing apparatuses, the processing flow setting unit selects an image processing apparatus to be used for the image processing from among image processing apparatuses available after the change. Furthermore, there may be further provided, for example, a display unit that displays processing performance of the plurality of image processing apparatuses and the processing flow set in the processing flow setting unit; and an operation unit that is provided on a display screen of the display unit and receives a user's instruction issued on the basis of display on the display unit. Thus, the processing flow setting unit may change the processing order of the multiple types of image processing and the selected image processing apparatus according to the user's instruction.

A second aspect of the present technology is an image processing control method including:

causing a processing flow setting unit to set a processing flow for each set of multiple types of image processing to be performed on an input image by selecting an image processing apparatus to be used for each of the multiple types of image processing on the basis of results of evaluating image qualities of processed images obtained from a test image processed by a plurality of image processing apparatuses.

### BRIEF DESCRIPTION OF DRAWINGS

FIG. 1 is a diagram illustrating a configuration of an image processing system.

FIG. 2 is a diagram illustrating a configuration of a first embodiment of an image processing control apparatus.

FIG. 3 is a diagram illustrating a processing performance profile.

FIG. 4 is a diagram illustrating a processing flow profile.

FIG. 5 is a diagram illustrating processing.

FIG. 6 is a flowchart illustrating operation of the first embodiment.

FIG. 7 is a diagram illustrating processing performance profiles.

FIG. 8 is a diagram showing an example of operation of the image processing control apparatus.

FIG. 9 is a flowchart illustrating operation of a second embodiment.

FIG. 10 is a diagram showing an example of operation of an image processing control apparatus.

FIG. 11 is a diagram illustrating a configuration of a third embodiment.

FIG. 12 is a flowchart illustrating operation of the third embodiment.

FIG. 13 is a flowchart illustrating user's instruction response processing.

FIG. 14 is a diagram illustrating a case where qualitative image quality is given priority over quantitative image quality in resolution conversion.

FIG. 15 is a diagram illustrating a case where processing order has been changed.

FIG. 16 is a diagram for describing a user's instruction (for example, a tap operation).

FIG. 17 is a diagram for describing a user's instruction (for example, a drag operation).

FIG. 18 is a flowchart illustrating operation of another embodiment.

FIG. 19 is a diagram illustrating a configuration to be adopted in a case where image quality is evaluated by use of a display image subjected to image processing.

FIG. 20 is a diagram showing an example of operation to be performed in a case where image quality is evaluated by use of a display image subjected to image processing.

### MODE FOR CARRYING OUT THE INVENTION

Modes for carrying out the present technology will be described below. Note that description will be provided in the following order.

1. Regarding Image Processing System

2. First Embodiment

2-1. Configuration of First Embodiment

2-2. Operation of First Embodiment

3. Second Embodiment

3-1. Configuration and Operation of Second Embodiment

4. Third Embodiment

4-1. Configuration of Third Embodiment

4-2. Operation of Third Embodiment

5. Regarding Other Embodiments

5-1. Regarding System Configuration

5-2. Regarding Image Quality

6. Application Examples

### 1. REGARDING IMAGE PROCESSING SYSTEM

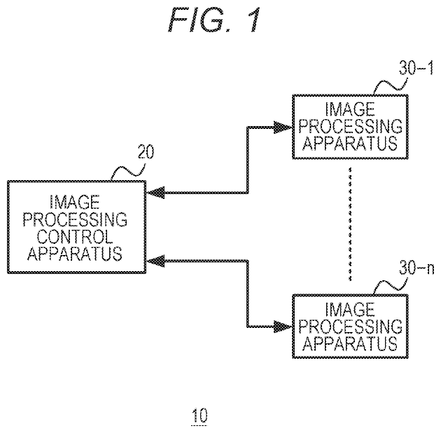

FIG. 1 shows a configuration of an image processing system using an image processing control apparatus of the present technology. An image processing system 10 includes an image processing control apparatus 20 and a plurality of image processing apparatuses 30-1 to 30-n. The image processing control apparatus 20 and the plurality of image processing apparatuses 30-1 to 30-n are connected via a wired or wireless transmission path. Furthermore, the image processing control apparatus 20 may be configured separately from the image processing apparatuses 30-1 to 30-n, or may be built into any of the image processing apparatuses 30-1 to 30-n.

The image processing control apparatus 20 acquires the processing performance of the image processing apparatuses 30-1 to 30-n, and causes the image processing apparatuses 30-1 to 30-n to process test images appropriate to their own processing performance. Alternatively, the image processing control apparatus 20 sets a processing flow for each set of multiple types of image processing to be performed on an input image, by selecting an image processing apparatus to be used for each of the multiple types of image processing on the basis of results of evaluating image qualities of processed images obtained from a test image processed by a plurality of image processing apparatuses. The test image is an image generated as a result of performing, on an evaluation image, processing that is the reverse of each of the multiple types of image processing. Image evaluation results are the results of evaluating the image qualities of the processed images with respect to the evaluation image.

In the selection of an image processing apparatus to be used for image processing, the image processing control apparatus 20 may select an image processing apparatus that produces the best image quality evaluation result for each of multiple types of image processing. Alternatively, the image processing control apparatus 20 may select a combination of image processing apparatuses producing the best result of evaluating the image quality of an output image from among combinations of respective image processing apparatuses to be used for the multiple types of image processing, the output image being obtained as a result of performing the multiple types of image processing on the input image. Moreover, the image processing control apparatus 20 controls operation of the image processing apparatuses 30-1 to 30-n so that image processing is performed according to the set processing flow.

For example, the image processing apparatuses 30-1 to 30-n each notify the image processing control apparatus 20 of processing performance, perform image processing on a test image supplied from the image processing control apparatus 20, return a processed test image, and perform image processing on an input image on the basis of a control signal from the image processing control apparatus 20.

### 2. REGARDING FIRST EMBODIMENT

### 2-1. Configuration of First Embodiment

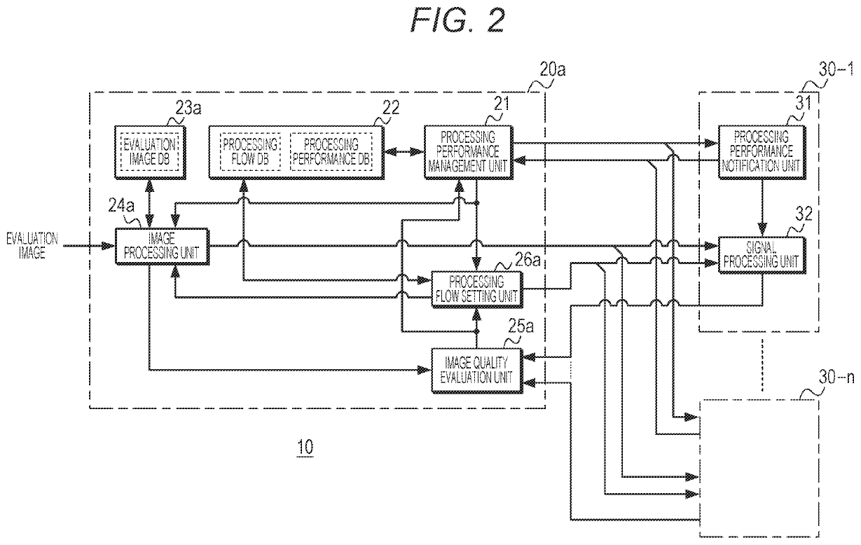

Next, a first embodiment will be described. In the first embodiment, a description will be given of the case of setting an optimum processing flow by selecting, for each image processing, an image processing apparatus that produces the best image quality evaluation result. FIG. 2 illustrates a configuration of the first embodiment of the image processing control apparatus. Note that FIG. 2 shows a case where an image processing control apparatus 20a includes a processing performance management unit 21, an information storage unit 22, an image storage unit 23a, an image processing unit 24a, an image quality evaluation unit 25a, and a processing flow setting unit 26a.

The processing performance management unit 21 inquires of the image processing apparatuses 30-1 to 30-n about performance and acquires processing performance, or acquires the processing performance of which the processing performance management unit 21 has been notified by the image processing apparatuses 30-1 to 30-n without inquiring of the image processing apparatuses 30-1 to 30-n about performance. Then, the processing performance management unit 21 stores, in the information storage unit 22, processing performance profiles indicating the acquired processing performance. Furthermore, the processing performance management unit 21 includes image quality evaluation results obtained by the image quality evaluation unit 25a in the processing performance profiles. The processing performance management unit 21 acquires, from the information storage unit 22, the processing performance profiles of the image processing apparatuses 30-1 to 30-n connected to the image processing control apparatus 20a, and outputs the acquired processing performance profiles to the image processing unit 24a and the processing flow setting unit 26a.

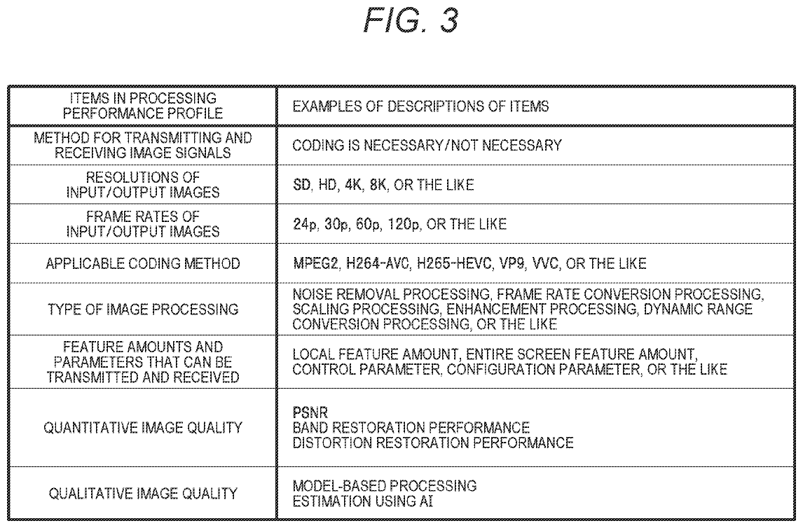

FIG. 3 illustrates a processing performance profile. Examples of items shown In the processing performance profile include a method for transmitting and receiving image signals, the resolutions of input/output images, the frame rates of input/output images, an applicable coding method, the type of image processing, feature amounts and parameters that can be transmitted and received, qualitative image quality, and quantitative image quality.

The item “method for transmitting and receiving image signals” indicates whether or not coding is required when image signals are transmitted and received.

The item “resolutions of input/output images” indicates which of standard definition (SD), high definition (HD), 4K, 8K, or the like corresponds to the resolution of each of an input image and an output image. The item “frame rates of input/output images” indicates which of 24 p, 30 p (progressive), 60 p, 120 p, or the like corresponds to the frame rate of each of an input image and an output image.

The item “applicable coding method” indicates which of coding methods such as MPEG2, H.264-AVC, H.265-HEVC, VP9, and VVC is applicable.

The item “type of image processing” indicates which of processing such as noise removal processing, frame rate conversion processing, scaling processing, enhancement processing, and dynamic range conversion processing can be performed.

The item “feature amounts and parameters that can be transmitted and received” indicates, for example, a local feature amount and an entire screen feature amount calculated from a test image, image quality adjustment parameters (settings such as the on/off and strength/weakness of an image quality adjustment function, an adjustment parameter set for image quality adjustment, and the like), and various settings and control information at the time of coding.

The item “quantitative image quality” indicates a peak signal-to-noise ratio (PSNR), band restoration performance indicating whether no decrease is shown in a high frequency range of frequency characteristics, distortion restoration performance indicating whether a decrease is shown in the high frequency range of frequency characteristics, an image feature amount such as the absolute value of a difference between adjacent pixels, a result of detecting distortion to be processed by a deblocking filter for coding processing, and the like.

The item “qualitative image quality” indicates, for example, a result of model-based qualitative image quality evaluation or a result of qualitative image quality evaluation using deep learning such as Convolution Neural Network (CNN). Examples of the evaluation results include an image quality evaluation score calculated by use of a method described in the document “Blind Image Quality Assessment via Deep Learning” (Weilong Hou, Xinbo Gao, Dacheng Tao, Xuelong Li, IEEE TRANSACTIONS ON NEURAL NETWORKS AND LEARNING SYSTEMS, VOL. 26, NO. 6, June 2015) and a value indicating the degree of similarity of a processed image with respect to an evaluation image calculated by use of a method described in “The Unreasonable Effectiveness of Deep Features as a Perceptual Met” (Richard Zhang, Phillip Isola, Alexei A. Efros, Eli Shechtman, Oliver Wang, CVPR 2018). Note that the evaluation image and the processed image will be described later.

Returning to FIG. 2, the information storage unit 22 stores the processing performance profiles acquired by the processing performance management unit 21. Furthermore, the information storage unit 22 stores a processing flow profile showing a processing flow set in the processing flow setting unit 26a to be described later and the image quality evaluation results obtained by the image quality evaluation unit 25a when image processing is performed according to the set processing flow. The information storage unit 22 outputs the processing performance profile in response to a request from the processing performance management unit 21, and outputs the processing flow profile in response to a request from the processing flow setting unit 26a.

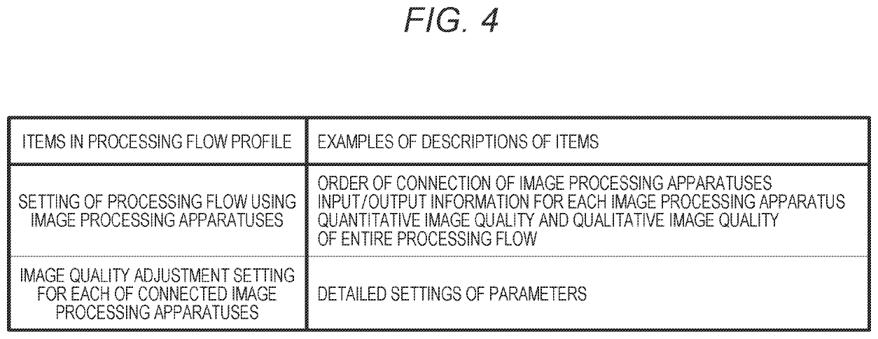

FIG. 4 illustrates the processing flow profile. For example, a processing flow setting state and an image quality adjustment setting state for each image processing apparatus are shown in the processing flow profile.

The item “processing flow setting state” indicates the order of image processing apparatuses that perform image processing, input/output information for each image processing apparatus (images, feature amounts, control parameters, and the like), results of evaluating image quality when image processing is performed on the basis of the processing flow, and the like. The item “image quality adjustment setting state for each image processing apparatus” indicates detailed settings of parameters of the image processing apparatus (for example, settings such as the on/off and strength/weakness of a function and an adjustment parameter set). Note that the processing flow profile may include the qualitative image quality and quantitative image quality of each image processing apparatus to be used for image processing.

An evaluation image for evaluating the image quality of image processing is stored in the image storage unit 23a in advance. The image storage unit 23a outputs the evaluation image in response to a request from the image processing unit 24a.

For each of the image processing apparatuses 30-1 to 30-n, the image processing unit 24a generates a test image by performing processing appropriate to the processing performance of the image processing apparatus on the evaluation image stored in the image storage unit 23a or an evaluation image supplied from the outside (for example, a received image obtained by receipt of a broadcast signal or a distribution signal, or an image reproduced from a recording medium). Furthermore, the image processing unit 24a outputs the generated test image to the corresponding image processing apparatus. Moreover, the image processing unit 24a outputs the evaluation image used for generating the test image to the image quality evaluation unit 25a so that the image quality of a processed image can be evaluated for each of the image processing apparatuses 30-1 to 30-n. Note that performed in the processing is the reverse of image processing to be performed by each of the image processing apparatuses 30-1 to 30-n.

### Evaluation Image Supplied from the Outside

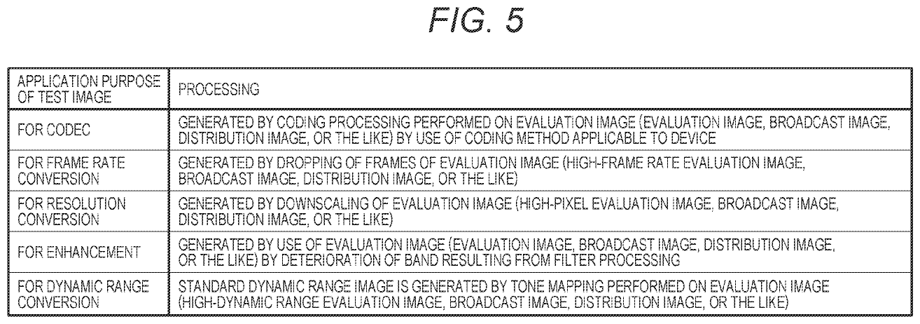

FIG. 5 illustrates the processing to be performed by the image processing unit 24a. The image processing unit 24a generates a test image by performing, on the evaluation image, the processing that is the reverse of image processing. The image processing unit 24a generates a test image corresponding to the processing performance of each of the image processing apparatuses 30-1 to 30-n, such as coding, frame rate conversion, resolution conversion (for example, for up-conversion), enhancement processing, and dynamic range conversion.

For example, in the generation of a test image to be used for coding, the evaluation image is coded in a coding method supported by the image processing apparatus, such as MPEG2, H.264-AVC, H.265-HEVC, VP9, or VVC. Furthermore, in a case where a coding method supported by the image processing apparatus is not clear, a test image is generated for each coding method.

In the generation of a test image to be used for frame rate conversion, frames of the evaluation image are dropped so as to achieve a low frame rate supported by the image processing apparatus. Furthermore, in a case where a frame rate supported by the image processing apparatus is not clear, a test image is generated for each preset frame rate.

In the generation of a test image to be used for resolution conversion, the evaluation image is downscaled so as to achieve a resolution supported by the image processing apparatus. Furthermore, in a case where the resolution supported by the image processing apparatus is not clear, a test image is generated for each preset resolution.

In the generation of a test image to be used for enhancement processing, a filter is used to deteriorate the band of the evaluation image. For example, a low-pass filter or a band-pass filter is used to remove a high-frequency component such as texture from the evaluation image in generating a test image.

In the generation of a test image to be used for dynamic range conversion, the evaluation image having a high dynamic range is converted into an image having a low dynamic range by use of a tone mapping function.

Returning to FIG. 2, the image quality evaluation unit 25a evaluates the image quality of a processed image obtained for each of the image processing apparatuses 30-1 to 30-n by using the processed image and the evaluation image, and outputs the results of image quality evaluation to the processing performance management unit 21.

The processing flow setting unit 26a sets an optimum processing flow by selecting image processing apparatuses that produce the best image quality evaluation results for each processing order of multiple types of image processing to be performed on an input image, on the basis of the processing performance profiles supplied from the processing performance management unit 21. Furthermore, the processing flow setting unit 26a generates a control signal so as to cause image processing to be performed according to the set optimum processing flow, and outputs the control signal to each image processing apparatus. Moreover, the processing flow setting unit 26a stores a processing flow profile indicating the set optimum processing flow in the information storage unit 22. Furthermore, in a case where the parameters of the image processing apparatus can be adjusted, the processing flow setting unit 26a sets parameters that produce the best result of evaluating the image quality of a processed image to be obtained as a result of performing image processing on a test image.

The image processing apparatuses 30-1 to 30-n each include a processing performance notification unit 31 and a signal processing unit 32. The processing performance notification unit 31 notifies the image processing control apparatus 20 of the processing performance of the image processing apparatus. Note that notification of the processing performance may be provided to the image processing control apparatus 20 in response to a request from the image processing control apparatus 20, or may be provided in a case where connection with the image processing control apparatus 20 is detected. The signal processing unit 32 sets operation on the basis of the control signal from the processing flow setting unit 26a of the image processing control apparatus 20, performs signal processing on the input image, and outputs the signal-processed input image.

### 2-2. Operation of First Embodiment

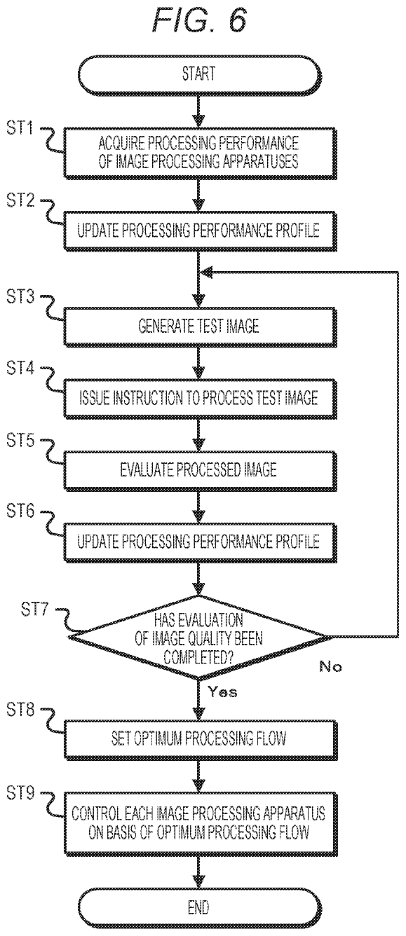

Next, operation of the first embodiment will be described. FIG. 6 is a flowchart illustrating operation of the first embodiment.

In step ST1, the image processing control apparatus acquires the processing performance of the image processing apparatuses. The image processing control apparatus 20 acquires information indicating processing performance from the image processing apparatuses 30-1 to 30-n connected to the image processing control apparatus 20, and proceeds to step ST2.

In step ST2, the image processing control apparatus updates the processing performance profile. The image processing control apparatus 20 updates the processing performance profile stored in the information storage unit 22 on the basis of the processing performance acquired in step ST1, and proceeds to step ST3.

In step ST3, the image processing control apparatus generates a test image. The image processing control apparatus 20 generates, from an evaluation image, a test image corresponding to the processing performance of an image processing apparatus newly added to the processing performance profile, and proceeds to step ST4.

In step ST4, the image processing control apparatus issues an instruction to process the test image. The image processing control apparatus 20 performs operation control so that image processing of the test image generated in step ST3 is performed by the newly added image processing apparatus, and proceeds to step ST5.

In step ST5, the image processing control apparatus evaluates a processed image. The image processing control apparatus 20 acquires a processed image obtained as a result of processing the test image according to the instruction issued in step ST4. Furthermore, the image processing control apparatus 20 evaluates image quality by using the evaluation image and the processed image, and proceeds to step ST6.

In step ST6, the image processing control apparatus updates the processing performance profile. The image processing control apparatus 20 stores an image quality evaluation result obtained in step ST5 in the processing performance profile, and proceeds to step ST7.

In step ST7, the image processing control apparatus determines whether evaluation of image quality has been completed. The image processing control apparatus 20 determines whether evaluation of the image quality of the processed image has been completed for the newly added image processing apparatus. In a case where image quality evaluation for any of the image processing apparatuses has not been completed, the image processing control apparatus 20 returns to step ST3. Then, the image processing control apparatus 20 generates a test image appropriate to the processing performance of the image processing apparatus with image quality yet to be evaluated, and causes image processing and evaluation of the image quality of a processed image to be performed. Furthermore, the image processing control apparatus 20 proceeds to step ST8 in a case where image quality evaluation of the processed image has been completed for the newly added image processing apparatus.

In step ST8, the image processing control apparatus sets an optimum processing flow. In a case where, for example, multiple items of preset image processing are performed on the input image, the image processing control apparatus sets an optimum processing flow by selecting an image processing apparatus that produces the best result of image quality evaluation for each item, and proceeds to step ST9.

In step ST9, the image processing control apparatus controls each image processing apparatus on the basis of the optimum processing flow. The image processing control apparatus 20 controls the operation of each image processing apparatus so that image processing is performed according to the optimum processing flow set in step ST8 by use of a plurality of the image processing apparatuses.

Note that in step ST9 of FIG. 6, the operation of each image processing apparatus is controlled on the basis of the optimum processing flow. Meanwhile, it is also possible to perform a process of storing, in the information storage unit 22, the optimum processing flow in association with configuration information indicating the image processing apparatuses connected to the image processing control apparatus. In this case, it is possible to promptly perform optimum image processing without performing image quality evaluation or the like, by acquiring, from the information storage unit 22, an optimum processing flow corresponding to a configuration identical to the configuration of the connected image processing apparatuses when performing image processing.

Next, an example of operation of the first embodiment will be described. Note that a case where an image with a frame rate of 60 p at HD resolution is converted into an image with a frame rate of 120 p at 4K resolution by use of HEVC as a coding method will be illustrated in the example of operation of the first embodiment.

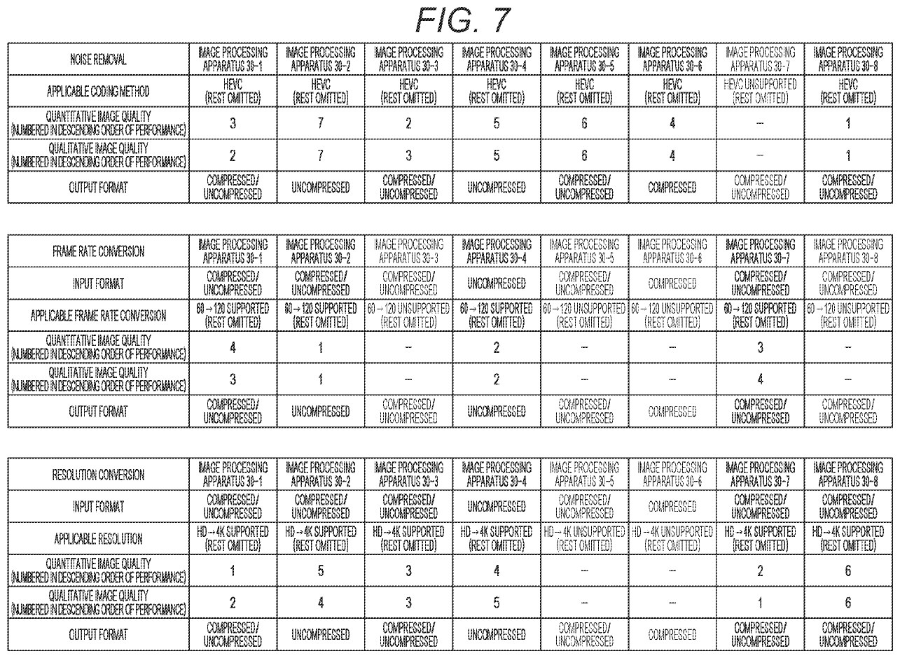

FIG. 7 illustrates the processing performance profiles of the image processing apparatuses 30-1 to 30-8 in the case of performing noise removal processing, frame rate conversion, and resolution conversion as image processing.

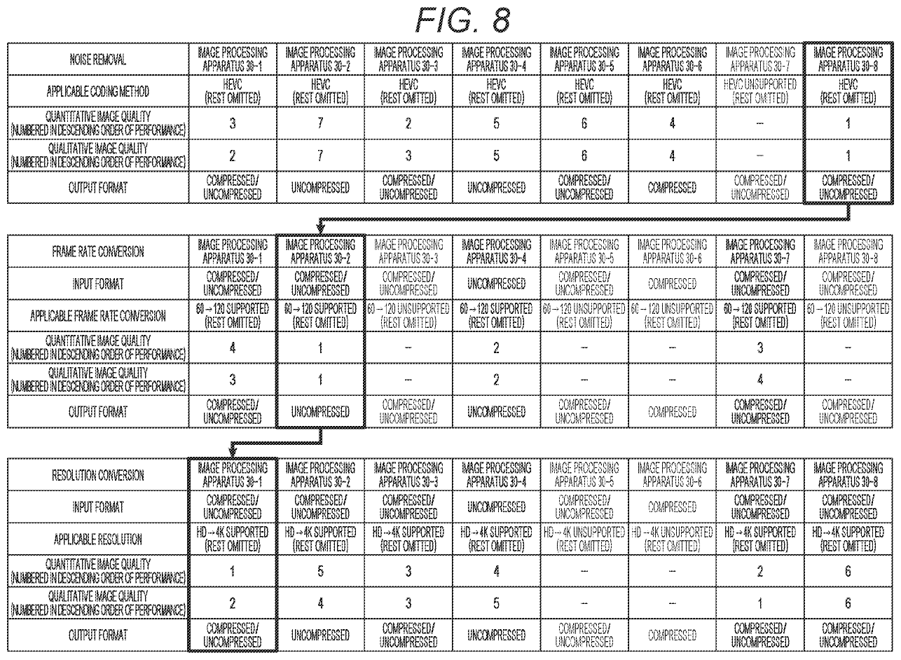

Information to be used as processing performance related to noise removal processing is information regarding, for example, an applicable coding method, quantitative image quality, qualitative image quality, and output format. For the image processing apparatus 30-1, it is shown that the image processing apparatus 30-1 supports a coding method such as the HEVC standard, quantitative image quality and qualitative image quality after noise removal processing is “3” and “2”, respectively, and both compressed and uncompressed formats are supported as output formats. Furthermore, it is shown that, for example, the image processing apparatus 30-2 does not support the compressed format as output format. In addition, since the image processing apparatus 30-7 does not support a coding method such as the HEVC standard, the symbol “-” is shown in the fields of the quantitative image quality and the qualitative image quality so as to indicate that there is no evaluation. Note that in FIG. 7 and FIGS. 8, 10, 14, and 15 to be described later, the greater a numerical value indicating image quality is, the lower the image quality is, and the symbol “-” indicates that there is no evaluation.

Information to be used as processing performance related to frame rate conversion is information regarding, for example, an input format, an applicable frame rate, quantitative image quality, qualitative image quality, and an output format. For the image processing apparatus 30-1, it is shown that both the compressed and uncompressed formats are supported as input formats, a frame rate can be converted from 60 p to 120 p or the like, quantitative image quality and qualitative image quality after frame rate conversion is “4” and “3”, respectively, and both the compressed and uncompressed formats are supported as output formats. Furthermore, for example, since the image processing apparatus 30-3 does not support frame rate conversion from 60 p to 120 p, there is no evaluation for quantitative image quality and qualitative image quality.

Information to be used as processing performance related to resolution conversion is information regarding, for example, an input format, an applicable resolution, quantitative image quality, qualitative image quality, and an output format. For the image processing apparatus 30-1, it is shown that both the compressed and uncompressed formats are supported as input formats, resolution can be converted from HD resolution to 4K resolution or the like, quantitative image quality and qualitative image quality after resolution conversion is “1” and “2”, respectively, and both the compressed and uncompressed formats are supported as output formats. Furthermore, for example, since the image processing apparatus 30-5 does not support resolution conversion from HD resolution to 4K resolution, there is no evaluation for quantitative image quality and qualitative image quality.

FIG. 8 shows an example of operation of the image processing control apparatus. For example, the processing flow setting unit 26a sets a processing flow by selecting an image processing apparatus that achieves the best image quality for each processing on the basis of processing performance related to noise removal processing, processing performance related to frame rate conversion, and processing performance related to resolution conversion. Therefore, the following processing flow is set as an optimum processing flow: the image processing apparatus 30-8 is used to perform noise removal processing, the image processing apparatus 30-2 is used to perform frame rate conversion processing on an image subjected to the noise removal processing, and the image processing apparatus 30-1 is used to perform resolution conversion processing on the image subjected to the frame rate conversion processing. Furthermore, the processing flow set in the processing flow setting unit 26a and the image quality performance are stored in the information storage unit 22 so that the processing flow and the image quality performance can be reused.

According to the first embodiment as described above, an optimum processing flow can be automatically set so as to achieve optimum image quality in each image processing on the basis of the processing performance profiles of a plurality of image processing apparatuses connected to the image processing control apparatus.

### 3. REGARDING SECOND EMBODIMENT

Incidentally, in the first embodiment, the case where an image processing apparatus that produces the best image quality evaluation result is selected for each image processing has been described. Meanwhile, described in a second embodiment is a case where an optimum processing flow is set by selection of a combination of image processing apparatuses that produces the best result of evaluating the image quality of an output image to be obtained as a result of performing multiple types of image processing on an input image.

### 3-1. Configuration and Operation of Second Embodiment

The second embodiment and the first embodiment are configured in a similar manner. However, the second embodiment differs from the first embodiment in operation of a processing performance management unit 21, an image processing unit 24a, and a processing flow setting unit 26a.

The processing performance management unit 21 inquires of the image processing apparatuses 30-1 to 30-n about performance and acquires processing performance, or acquires the processing performance of which the processing performance management unit 21 has been notified by the image processing apparatuses 30-1 to 30-n without inquiring of the image processing apparatuses 30-1 to 30-n about performance. Then, the processing performance management unit 21 stores, in the information storage unit 22, processing performance profiles indicating the acquired processing performance. Furthermore, the processing performance management unit 21 acquires, from the information storage unit 22, the processing performance profiles of the image processing apparatuses 30-1 to 30-n connected to an image processing control apparatus 20a, and outputs the acquired processing performance profiles to the processing flow setting unit 26a.

The image processing unit 24a performs generation by performing processing on an evaluation image stored in an image storage unit 23a or an evaluation image supplied from the outside on the basis of a processing flow set in the processing flow setting unit 26a, the processing being the reverse of multiple types of image processing to be performed on an input image. The image processing unit 24a provides an output to an image processing apparatus to be used at the beginning of the processing flow set in the processing flow setting unit 26a. Furthermore, the image processing unit 24a outputs an evaluation image used for generating a test image to an image quality evaluation unit 25a so as to enable evaluation of the image quality of a processed image output from an image processing apparatus used at the end of the processing flow.

On the basis of a processing performance profile supplied from the processing performance management unit 21, the processing flow setting unit 26a sets a plurality of processing flows for each set of multiple types of image processing to be performed on the input image by changing combinations of respective image processing apparatuses to be used for the multiple types of image processing. For each of the set processing flows, the processing flow setting unit 26a causes the image processing unit 24a to generate a test image corresponding to the processing flow, and outputs control signals to selected image processing apparatuses so that the image processing apparatuses perform image processing according to the set processing flow. Furthermore, in a case where parameters of an image processing apparatus to be used for each image processing can be adjusted, the processing flow setting unit 26a sets parameters that produce the best result of evaluating the image quality of an output image to be obtained as a result of performing multiple types of image processing on the input image. Moreover, for each of the set processing flows, the processing flow setting unit 26a stores, in the information storage unit 22, a processing flow profile showing the processing flow and an image quality evaluation result supplied from the image quality evaluation unit 25a, or showing the processing flow, the image quality evaluation result, and parameters. Moreover, the processing flow setting unit 26a sets, as an optimum processing flow, a processing flow that produces the best image quality evaluation result, and outputs control signals to the selected image processing apparatuses so that the selected image processing apparatuses perform image processing according to the optimum processing flow. Thus, the processing flow setting unit 26a causes a plurality of the image processing apparatuses to perform image processing on the input image.

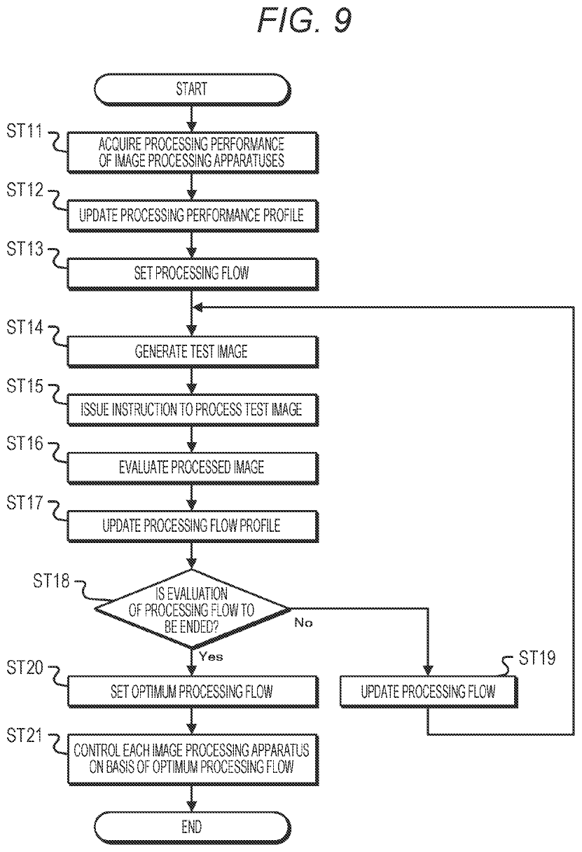

FIG. 9 is a flowchart illustrating operation of the second embodiment. In step ST11, the image processing control apparatus acquires the processing performance of the image processing apparatuses. An image processing control apparatus 20 acquires information indicating processing performance from the image processing apparatuses 30-1 to 30-n connected to the image processing control apparatus 20, and proceeds to step ST12.

In step ST12, the image processing control apparatus updates the processing performance profile. The image processing control apparatus 20 updates the processing performance profile stored in the information storage unit 22 on the basis of the processing performance acquired in step ST11, and proceeds to step ST13.

In step ST13, the image processing control apparatus sets a processing flow. The image processing control apparatus 20 sets a processing flow for performing image processing by using a plurality of image processing apparatuses on the basis of the processing performance profile stored in the information storage unit 22, and the process proceeds to step ST14.

In step ST14, the image processing control apparatus generates a test image. The image processing control apparatus 20 generates, from an evaluation image, a test image for performing image processing according to the processing flow set in step ST13, and proceeds to step ST15.

In step ST15, the image processing control apparatus issues an instruction to process the test image. The image processing control apparatus 20 controls operation of each image processing apparatus so that image processing is performed on the test image according to the processing flow set in step ST13, and proceeds to step ST16.

In step ST16, the image processing control apparatus evaluates a processed image. The image processing control apparatus 20 acquires a processed image obtained as a result of processing the test image according to the processing flow set in step ST13. Furthermore, the image processing control apparatus 20 evaluates image quality by using the evaluation image and the processed image, and proceeds to step ST17.

In step ST17, the image processing control apparatus updates the processing flow profile. The image processing control apparatus 20 generates a processing flow profile showing the processing flow set in step ST13 and an image quality evaluation result. Moreover, the image processing control apparatus 20 stores the generated processing flow profile in the information storage unit 22, and proceeds to step ST18.

In step ST18, the image processing control apparatus determines whether to end the processing flow evaluation. In a case where the image processing control apparatus 20 determines that evaluation of image quality is to be performed for a new processing flow on the basis of the processing performance profile, the process proceeds to step ST19. In a case where the image processing control apparatus 20 determines that evaluation of image quality for each processing flow is to be ended on the basis of the processing performance profile, the process proceeds to step ST20.

In step ST19, the image processing control apparatus updates the processing flow. The image processing control apparatus 20 updates the processing flow with a processing flow for which evaluation of image quality has not been performed. Then, the image processing control apparatus 20 returns to step ST15, and causes a test image to be processed according to the updated processing flow.

When it is determined in step ST18 that evaluation of image quality for the processing flow has been completed, the process proceeds to step ST20, and the image processing control apparatus sets an optimum processing flow. The image processing control apparatus 20 selects a processing flow profile that produces the best result of image quality evaluation from among the processing flow profiles stored in the information storage unit 22. Moreover, the image processing control apparatus 20 sets, as an optimum processing flow, a processing flow indicated by the processing flow profile that produces the best result of image quality evaluation, and proceeds to step ST21.

In step ST21, the image processing control apparatus controls each image processing apparatus on the basis of the optimum processing flow. The image processing control apparatus 20 controls the operation of each image processing apparatus so that image processing is performed according to the optimum processing flow set in step ST20 by use of the plurality of image processing apparatuses.

Note that in step ST21 of FIG. 9, the operation of each image processing apparatus is controlled on the basis of the optimum processing flow. Meanwhile, in step ST21, it is also possible to perform a process of storing, in the information storage unit 22, the optimum processing flow in association with configuration information indicating the image processing apparatuses connected to the image processing control apparatus. In this case, it is possible to promptly perform optimum image processing without performing image quality evaluation or the like, by acquiring, from the information storage unit 22, an optimum processing flow corresponding to a configuration identical to the configuration of the connected image processing apparatuses when performing image processing.

Next, an example of operation of the second embodiment will be described. Note that as in the example of operation of the second embodiment, a case where an image with a frame rate of 60 p at HD resolution is converted into an image with a frame rate of 120 p at 4K resolution by use of HEVC as a coding method will be illustrated in the example of operation of the second embodiment.

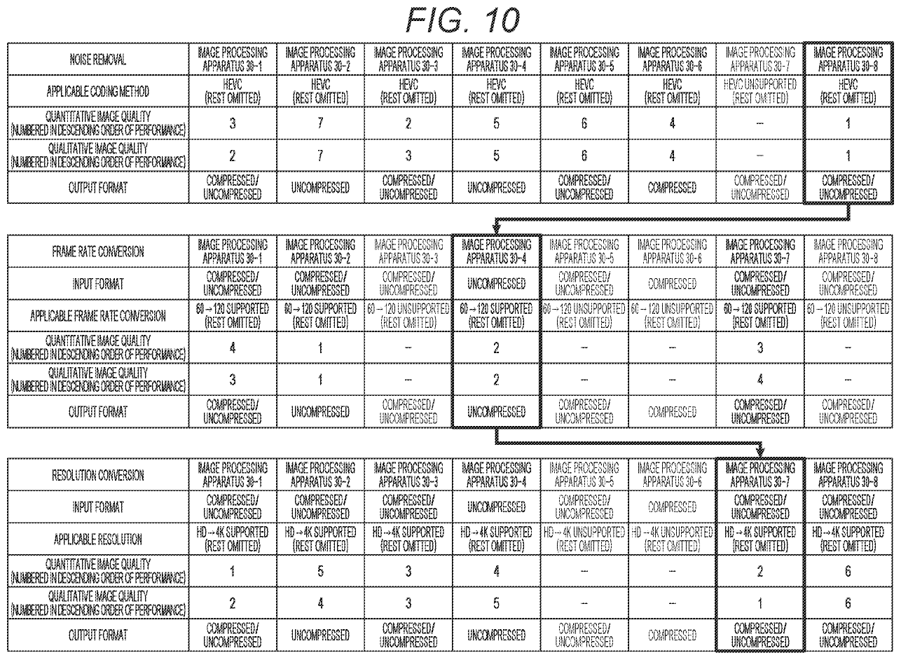

FIG. 10 shows an example of operation of the image processing control apparatus. For example, the processing flow setting unit 26a sets, as an optimum processing flow, a combination of image processing apparatuses that achieves the best image quality of a processed image to be obtained as a result of performing noise removal processing, frame rate conversion, and resolution conversion in order. Note that FIG. 10 shows a case where a processed image with the best image quality is obtained in the following processing flow: the image processing apparatus 30-8 is used to perform noise removal processing, the image processing apparatus 30-4 is used to perform frame rate conversion processing on an image subjected to the noise removal processing, and the image processing apparatus 30-7 is used to perform resolution conversion processing on the image subjected to the frame rate conversion processing.

As described above, according to the second embodiment, an optimum processing flow can be automatically set in such a way as to achieve the best image quality of an output image to be obtained as a result of performing multiple items of image processing on an input image.

### 4. REGARDING THIRD EMBODIMENT

### 4-1. Configuration of Third Embodiment

Next, a third embodiment will be described. In the first and second embodiments described above, the case where an optimum processing flow for obtaining an output image with optimum image quality is automatically set by the image processing control apparatus has been described. Meanwhile, described in the third embodiment is a case where a user can be involved in the setting of an optimum processing flow for obtaining a processed image with optimum image quality.

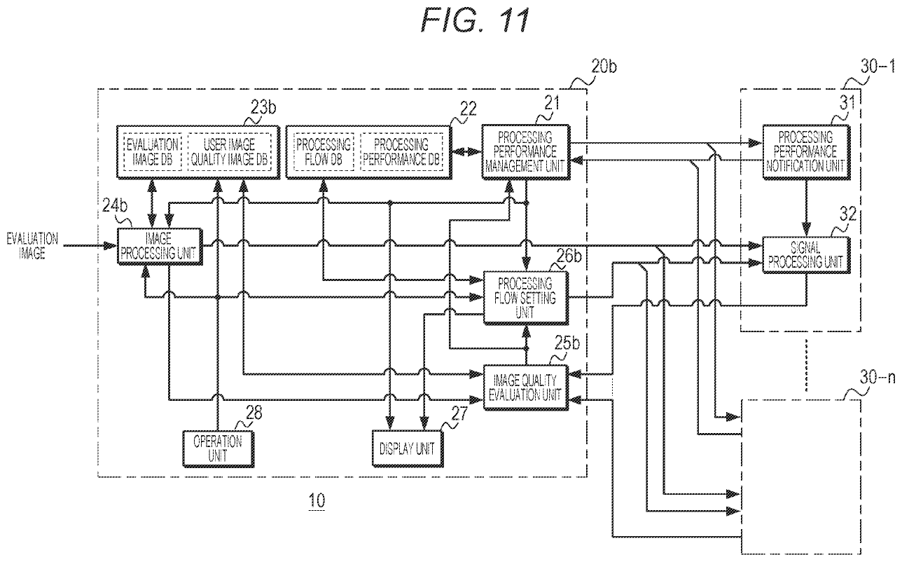

FIG. 11 illustrates a configuration of the third embodiment of the image processing control apparatus. Note that FIG. 11 illustrates a case where an image processing control apparatus 20b includes a processing performance management unit 21, an information storage unit 22, an image storage unit 23b, an image processing unit 24b, an image quality evaluation unit 25b, a processing flow setting unit 26b, a display unit 27, and an operation unit 28.

The processing performance management unit 21 inquires of the image processing apparatuses 30-1 to 30-n about performance and acquires processing performance, or acquires the processing performance of which the processing performance management unit 21 has been notified by the image processing apparatuses 30-1 to 30-n without inquiring of the image processing apparatuses 30-1 to 30-n about performance. Then, the processing performance management unit 21 stores, in the information storage unit 22, processing performance profiles indicating the acquired processing performance. Furthermore, the processing performance management unit 21 includes image quality evaluation results obtained by the image quality evaluation unit 25a in the processing performance profiles. The processing performance management unit 21 acquires, from the information storage unit 22, the processing performance profiles of the image processing apparatuses 30-1 to 30-n connected to the image processing control apparatus 20a, and outputs the processing performance profiles to the image processing unit 24b and the processing flow setting unit 26b.

The information storage unit 22 stores the processing performance profiles acquired by the processing performance management unit 21. Furthermore, the information storage unit 22 stores a processing flow profile showing a processing flow set in the processing flow setting unit 26b and the image quality evaluation result obtained by the image quality evaluation unit 25b. The information storage unit 22 outputs the processing performance profile in response to a request from the processing performance management unit 21, and outputs the processing flow profile in response to a request from the processing flow setting unit 26b.

An evaluation image for evaluating the image quality of image processing is stored in the image storage unit 23b in advance according to the image processing. The image storage unit 23b outputs an evaluation image in response to a request from the image processing unit 24b or in response to an operation signal indicating a user's instruction from the operation unit 28 to be described later.

The image processing unit 24b generates a test image by performing processing on the evaluation image stored in the image storage unit 23b or an evaluation image supplied from the outside on the basis of the processing performance of the image processing apparatus, the processing flow set in the processing flow setting unit 26b, or the operation signal. Furthermore, the image processing unit 24b outputs the generated test image to the corresponding image processing apparatus, and outputs the evaluation image used for generating the test image to the image quality evaluation unit 25b.

The image quality evaluation unit 25b acquires a processed image from the image processing apparatus, and evaluates the image quality of the processed image by using the evaluation image and the processed image. Then, the image quality evaluation unit 25b outputs a result of image quality evaluation to the processing performance management unit 21 or the processing flow setting unit 26b.

As in the first or second embodiment, the processing flow setting unit 26b sets an optimum processing flow, and controls operation of each image processing apparatus so that image processing is performed according to the set optimum processing flow. Furthermore, the processing flow setting unit 26b sets an optimum processing flow such that processing performance specified on the basis of the operation signal is emphasized in performing image processing or image processing is performed in specified processing order.

The display unit 27 displays the processing performance profile read by the processing performance management unit 21 and the processing flow set in the processing flow setting unit 26b. Furthermore, the operation unit 28 is provided on a display screen of the display unit 27, so that the display unit 27 and the operation unit 28 form a graphical user interface (GUI). The operation unit 28 generates an operation signal indicating a user's instruction issued on the basis of the display on the display unit 27.

The image processing apparatuses 30-1 to 30-n each include a processing performance notification unit 31 and a signal processing unit 32. The processing performance notification unit 31 notifies the image processing control apparatus 20b of the processing performance of the image processing apparatus. Note that notification of the processing performance may be provided to the image processing control apparatus 20b in response to a request from the image processing control apparatus 20b, or may be provided in a case where connection with the image processing control apparatus 20b is detected. The signal processing unit 32 sets operation on the basis of a control signal from the processing flow setting unit 26b of the image processing control apparatus 20b, performs signal processing on an input image, and outputs the signal-processed input image.

### 4-2. Operation of Third Embodiment

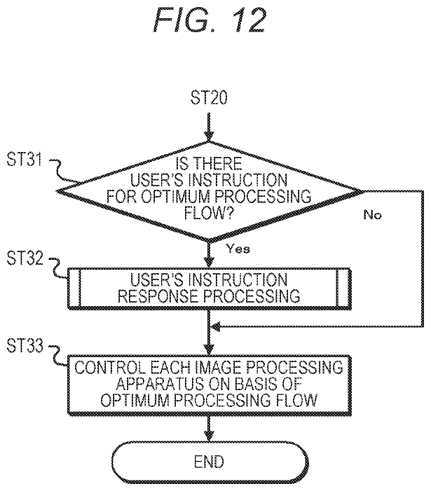

Next, operation of the third embodiment will be described. FIG. 12 is a flowchart illustrating operation of the third embodiment. Note that a case where processing of step ST31 and subsequent steps is performed after the processing of steps ST11 to ST20 of the first embodiment is illustrated in the third embodiment.

In step ST31, the image processing control apparatus determines whether there is a user's instruction for the optimum processing flow. The image processing control apparatus 20 proceeds to step ST32 in a case where it is determined that there is a user's instruction, or proceeds to step ST33 in a case where it is determined that there is no user's instruction.

In step ST32, the image processing control apparatus performs user's instruction response processing. In the user's instruction response processing, a processing flow based on the user's instruction is set as an optimum processing flow instead of the optimum processing flow set in step ST20.

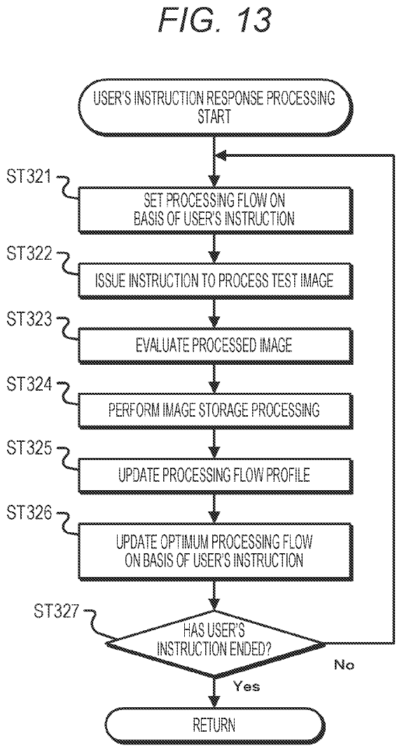

FIG. 13 is a flowchart illustrating the user's instruction response processing. In step ST321, the image processing control apparatus sets a processing flow on the basis of the user's instruction. For example, the image processing control apparatus selects image processing order and an image processing apparatus to be used for image processing, or specifies processing performance to be given priority, on the basis of the user's instruction indicated by an operation signal. Then, the process proceeds to step ST322.

In step ST322, the image processing control apparatus issues an instruction to process the test image. The image processing control apparatus causes a plurality of image processing apparatuses to process the test image according to the processing flow set in step ST321, and proceeds to step ST323.

In step ST323, the image processing control apparatus evaluates a processed image. The image processing control apparatus 20b acquires a processed image obtained as a result of processing the test image according to the processing flow set in step ST321. Furthermore, the image processing control apparatus 20 evaluates image quality by using the evaluation image and the processed image, and proceeds to step ST324.

In step ST324, the image processing control apparatus performs image storage processing. The image processing control apparatus stores, as a user image quality image, the processed image acquired in step ST323 in the image storage unit 23b.

In step ST325, the image processing control apparatus updates the processing flow profile. The image processing control apparatus 20 generates a processing flow profile showing the processing flow set in step ST321 and an image quality evaluation result. Moreover, the image processing control apparatus 20 stores the generated processing flow profile in the information storage unit 22, and proceeds to step ST326. Note that the image processing control apparatus 20b associates the processing flow profile with the user image quality image so that it is possible to check what kind of user image quality image is obtained in the case of performing image processing according to each kind of processing flow.

In step ST326, the image processing control apparatus updates the optimum processing flow on the basis of the user's instruction. The image processing control apparatus sets, as an optimum processing flow, a processing flow selected on the basis of the user's instruction, and proceeds to step ST327.

In step ST327, the image processing control apparatus determines whether the user's instruction has ended. In a case where the image processing control unit does not determine that the user's instruction has ended, the process returns to step ST321 to performs, for example, evaluation of the image quality of a processed image of a new processing flow based on the user's instruction. In a case where the image processing control unit determines that the user's instruction has ended, the process proceeds to step ST33 in FIG. 12.

In step ST33, the image processing control apparatus controls each image processing apparatus on the basis of the optimum processing flow. The image processing control apparatus 20 controls the operation of each image processing apparatus so that image processing is performed according to the optimum processing flow set in step ST20 or step ST326 by use of the plurality of image processing apparatuses.

Furthermore, in a case where the third embodiment is applied to the first embodiment, image processing apparatuses to be used for performing multiple types of image processing on an input image or processing order is set according to the user's instruction.

Next, an example of operation of the third embodiment will be described. Note that as in the first and second embodiments, a case where an image with a frame rate of 60 p at HD resolution is converted into an image with a frame rate of 120 p at 4K resolution by use of HEVC as a coding method will be illustrated in the example of operation of the third embodiment. Furthermore, image processing apparatuses to be used in the example of operation of the third embodiment are the same as those used in the examples of operation of the first and second embodiments.

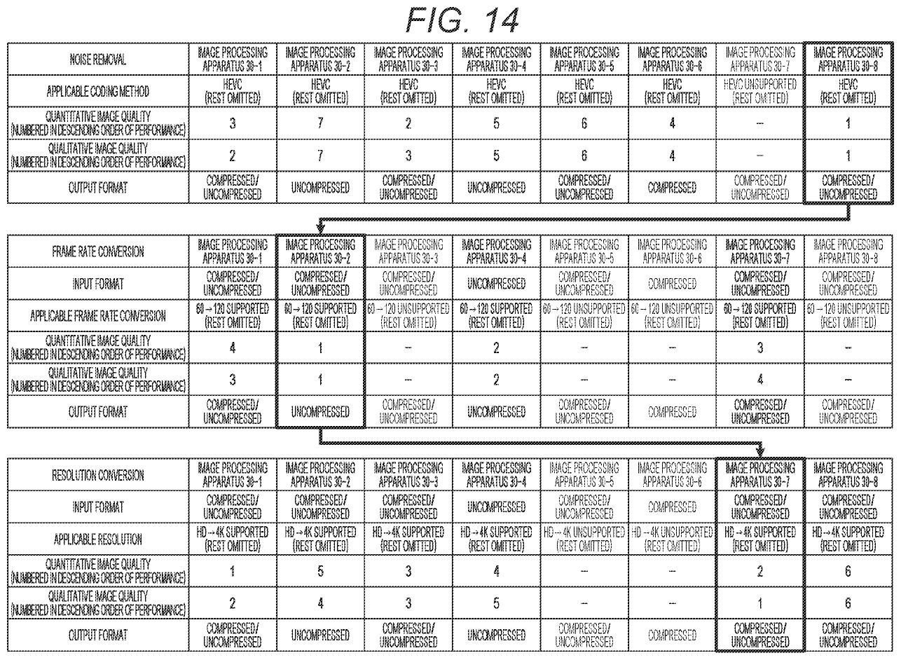

FIG. 14 illustrates a case where qualitative image quality is given priority over quantitative image quality in resolution conversion on the basis of a user's instruction. In this case, the image processing control apparatus selects the image processing apparatus 30-7 that achieves an optimum qualitative image quality for the resolution conversion on the basis of the user's instruction. That is, the image processing control apparatus 20b sets the following processing flow as an optimum processing flow: the image processing apparatus 30-8 is used to perform noise removal processing, the image processing apparatus 30-2 is used to perform frame rate conversion on an image subjected to the noise removal processing, and the image processing apparatus 30-7 is used to perform resolution conversion on the image subjected to the noise removal processing and the frame rate conversion.

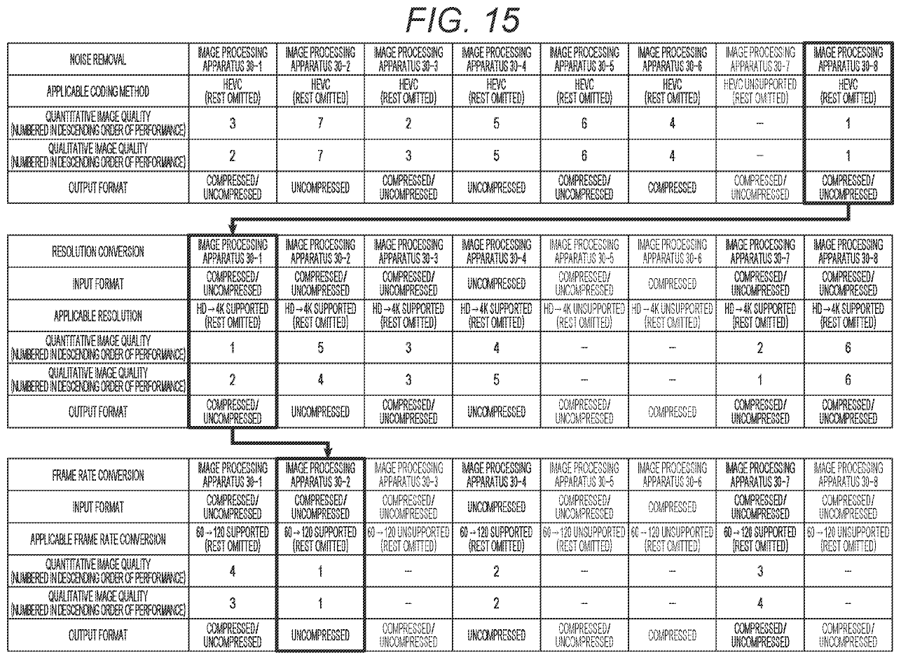

FIG. 15 illustrates a case where processing order has been changed on the basis of a user's instruction. For example, resolution conversion is performed after noise removal processing, and then, frame rate conversion is performed on an image subjected to the noise removal processing and the resolution conversion. In this case, the image processing control apparatus 20b sets, as an optimum processing flow, a processing flow that achieves the best image quality of a processed image obtained as a result of performing image processing in processing order based on the user's instruction. For example, the image processing control apparatus 20b sets the following processing flow as an optimum processing flow: the image processing apparatus 30-8 is used to perform noise removal processing, the image processing apparatus 30-1 is used to perform resolution conversion on an image subjected to the noise removal processing, and the image processing apparatus 30-2 is used to perform frame rate conversion on the image subjected to the noise removal processing and the resolution conversion.

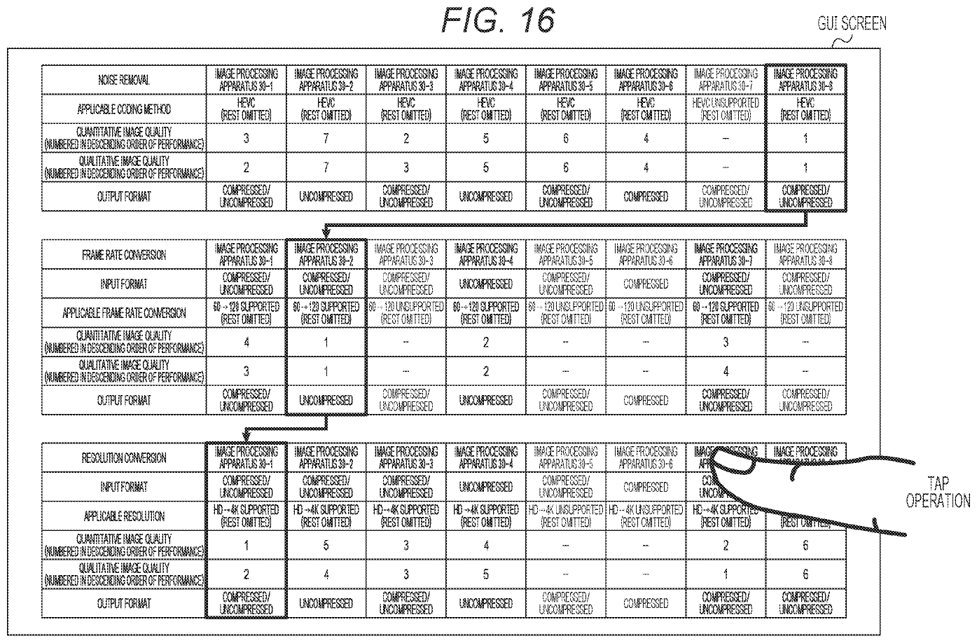

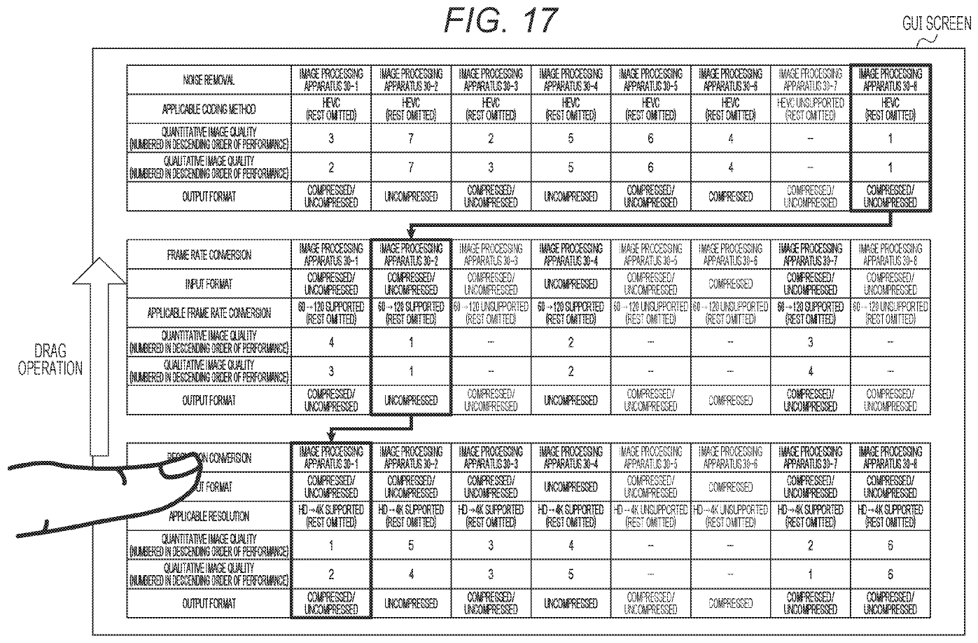

User's instructions are issued by use of, for example, the graphical user interface (GUI) including the display unit 27 and the operation unit 28. On the GUI screen, for example, image processing apparatuses that can be selected and image processing items are arranged two-dimensionally. FIGS. 16 and 17 are diagrams for describing user's instructions. On the GUI screen, for example, the image processing apparatuses that can be selected are arranged in a horizontal direction, and the image processing items are arranged in a vertical direction in the processing order. The image processing control apparatus 20b sets and updates a processing flow in response to a tap operation, a drag operation, or the like on the GUI screen. For example, as shown in FIG. 16, in a case where a tap operation is performed at a position corresponding to a desired processing item of any of a plurality of the image processing apparatuses, the image processing control apparatus 20 sets a processing flow such that image processing corresponding to the desired processing item is performed by the image processing apparatus corresponding to the position where the tap operation has been performed. Therefore, a processing flow shown in FIG. 16 can be changed to the processing flow shown in FIG. 14.

Furthermore, in a case where a drag operation for moving a desired processing item is performed as shown in FIG. 17, the image processing control apparatus 20 changes the order of the processing items according to the drag operation, and sets a processing flow such that image processing is performed in the changed processing order. Therefore, a processing flow shown in FIG. 17 can be changed to the processing flow shown in FIG. 15.

According to the third embodiment, since a user can be involved in the setting of a processing flow, a processing flow can be set such that it is possible to obtain a processed image with image quality desired by the user.

### 5. REGARDING OTHER EMBODIMENTS

### 5-1. Regarding System Configuration

In a case where image processing is performed by use of a plurality of image processing apparatuses, there may arise a case where a new image processing apparatus becomes available, or a case where any of the plurality of image processing apparatuses becomes unavailable due to disconnection from the image processing control apparatus. Therefore, an image processing control apparatus 20 may update an optimum processing flow according to addition or removal of an image processing apparatus.

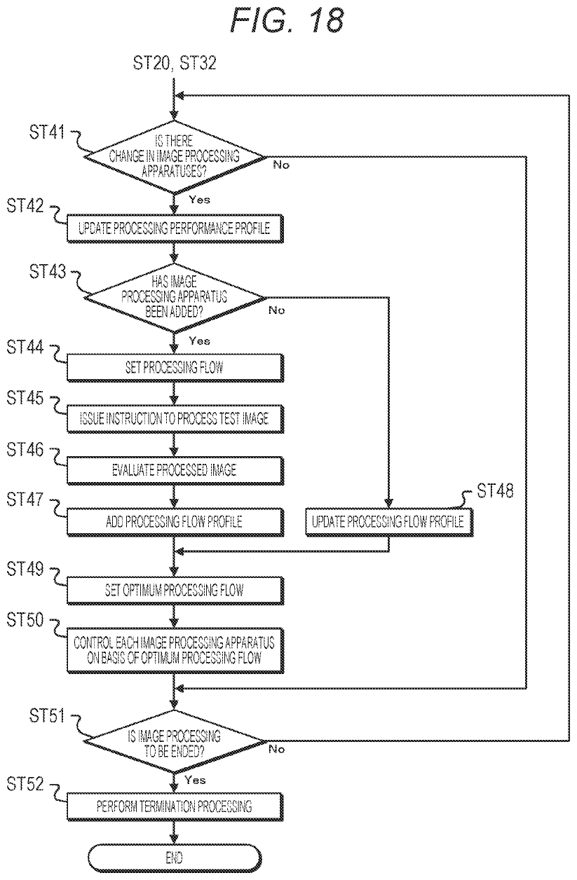

FIG. 18 is a flowchart illustrating operation of another embodiment. Note that FIG. 18 shows a case where an image processing apparatus is added or removed after, for example, the processing of either step ST20 or ST32 described above is performed in a situation where an optimum processing flow has been set.

In step ST41, the image processing control apparatus determines whether there is a change in connected image processing apparatuses. In a case where the image processing control apparatus 20 detects that a new image processing apparatus has been connected or an image processing apparatus has been disconnected, the image processing control apparatus 20 determines that there is a change in the connected image processing apparatuses, and proceeds to step ST42. In a case where the image processing control apparatus 20 determines that there is no change in the connected image processing apparatuses, the process proceeds to step ST51.

In step ST42, the image processing control apparatus updates a processing performance profile. The image processing control apparatus stores, in an information storage unit 22, a processing performance profile indicating the processing performance of the newly connected image processing apparatus. Furthermore, the image processing control apparatus may delete, from the information storage unit 22, a processing performance profile indicating the processing performance of the disconnected image processing apparatus. Alternatively, the image processing control apparatus may keep the processing performance profile regarding the disconnected image processing apparatus stored in the information storage unit 22 so that the processing performance profile can be reused when the disconnected image processing apparatus is connected again. The image processing control apparatus 20 updates the processing performance profile, and proceeds to step ST43.

In step ST43, the image processing control apparatus determines whether an image processing apparatus has been added. In a case where the change in the image processing apparatuses detected in step ST41 is addition of an image processing apparatus, the image processing control apparatus proceeds to step ST44. In a case where the change in the image processing apparatuses detected in step ST41 is removal of an image processing apparatus, the image processing control apparatus proceeds to step ST48.

In step ST44, the image processing control apparatus sets a processing flow. The image processing control apparatus 20 sets a processing flow for performing image processing by using a plurality of image processing apparatuses on the basis of the processing performance profile stored in the information storage unit 22, and the process proceeds to step ST45.

In step ST45, the image processing control apparatus issues an instruction to process the test image. The image processing control apparatus 20 controls operation of each image processing apparatus so that image processing of the test image is performed according to the processing flow set in step ST44, and proceeds to step ST46.

In step ST46, the image processing control apparatus evaluates a processed image. The image processing control apparatus 20 acquires a processed image obtained as a result of processing the test image according to the processing flow set in step ST44. Furthermore, the image processing control apparatus 20 evaluates image quality by using an evaluation image and the processed image, and proceeds to step ST47.

In step ST47, the image processing control apparatus adds a processing flow profile. The image processing control apparatus 20 generates a processing flow profile showing the processing flow set in step ST44 and an image quality evaluation result obtained in step ST46. Moreover, the image processing control apparatus 20 stores the generated processing flow profile in the information storage unit 22, and proceeds to step ST49.

When the process proceeds from step ST43 to step ST48, the image processing control apparatus updates the processing flow profile. The image processing control apparatus 20 deletes a processing flow file using the removed image processing apparatus, or sets the processing flow file as an unselectable processing flow profile, and proceeds to step ST49.

In step ST49, the image processing control apparatus sets an optimum processing flow. The image processing control apparatus 20 selects a processing flow profile that produces the best result of image quality evaluation from among processing flow profiles that are stored in the information storage unit 22 and are not unselectable processing flow profiles. Moreover, the image processing control apparatus 20 sets, as an optimum processing flow, a processing flow indicated by the processing flow profile that produces the best result of image quality evaluation, and proceeds to step ST50.

In step ST50, the image processing control apparatus controls each image processing apparatus on the basis of the optimum processing flow. The image processing control apparatus 20 controls operation of each image processing apparatus so that image processing is performed by use of the plurality of image processing apparatuses according to the optimum processing flow set in step ST49, and proceeds to step ST51.

In step ST51, the image processing control apparatus determines whether to end image processing. In a case where, for example, a user issues an instruction to end image processing or image processing on an image to be processed has been completed, the image processing control apparatus 20 determines that image processing is to be ended, and proceeds to step ST52. Furthermore, in a case where it is not determined that image processing is to be ended, the image processing control apparatus 20 returns to step ST41.

In step ST52, the image processing control apparatus performs termination processing. The image processing control apparatus 20 terminates the operation of the image processing apparatuses used in the optimum processing flow.

Note that in FIG. 18, the optimum processing flow has been set in such a way as to achieve the best image quality of an output image subjected to multiple items of image processing, but the optimum processing flow may be set by selection of an image processing apparatus that achieves the best image quality for each item. In this case, image processing is performed by use of a test image appropriate to the processing performance of an added image processing apparatus, and the image quality of a processed image is evaluated. Then, a result of the evaluation is included in the processing performance profile. Moreover, an image processing apparatus that produces the best result of image quality evaluation just needs to be selected for each image processing item on the basis of the processing performance profile.

Performing such processing enables an optimum processing flow to be set in such a way as to obtain a good processed image according to each situation even if an image processing apparatus to be connected to the image processing control apparatus 20 is added or an image processing apparatus connected to the image processing control apparatus 20 is removed.

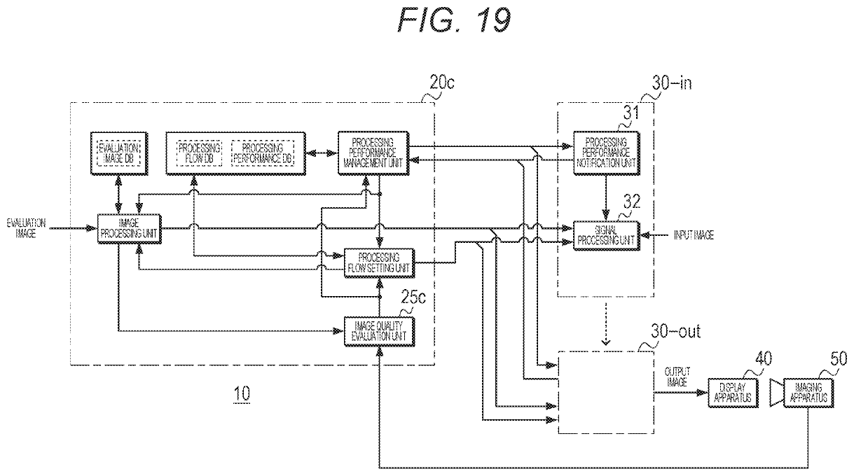

Furthermore, blocks included in the image processing control apparatuses shown in FIGS. 2 and 11 need not be integrally provided. For example, processing to be performed by the image processing unit and the image quality evaluation unit may be performed by an external device to reduce the load on each of the image processing control apparatuses. Moreover, the same applies to the image processing control apparatus shown in FIG. 19 to be described later.

### 5-2. Regarding Image Quality

Furthermore, in each of the operation examples of the above-described embodiments, quantitative image quality and qualitative image quality are separately used to set an optimum processing flow. Meanwhile, an optimum processing flow may be set on the basis of an integrated score of quantitative image quality and qualitative image quality. For example, a weighted sum of quantitative image quality and qualitative image quality is used as an integrated score QT. Equation (1) exemplifies a formula for calculating the integrated score QT. Note that an improvement amount Qa of PSNR and a score Qb indicating qualitative image quality are used in equation (1), where “Wa” denotes weight for the improvement amount Qa and “Wb” denotes weight for the score Qb.

QT=Wa×Qa+Wb×Qb (1)

Furthermore, the cases where evaluation of image quality is performed by use of processed images generated by image processing apparatuses have been illustrated in the above-described embodiments. Meanwhile, image quality may be evaluated on the basis of an actual display state. FIG. 19 illustrates a configuration to be adopted in a case where image quality is evaluated by use of a display image subjected to image processing. An image processing system includes an image processing control apparatus 20c, a plurality of image processing apparatuses 30-in to 30-out, a display apparatus 40, and an imaging apparatus 50. Note that the image processing control apparatus 20c and the image processing control apparatus 20a (20b) described above are configured in a similar manner. However, an image quality evaluation unit of the image processing control apparatus 20c uses an image different from that to be used in the image quality evaluation unit 25a (25b). That is, an image quality evaluation unit 25c of the image processing control apparatus 20c uses a captured image acquired by the imaging apparatus 50. Furthermore, an input image to be image-processed is input to the image processing apparatus 30-in, and an output image subjected to image processing is output from the image processing apparatus 30-out.

The display apparatus 40 displays the output image output from the image processing apparatus 30-out. The imaging apparatus 50 captures an image of the output image displayed by the display apparatus 40, and outputs the captured image to the image quality evaluation unit 25c of the image processing control apparatus 20c. Furthermore, the display apparatus 40 may superimpose, on a processed image, area display indicating an image area to be used for image quality evaluation, and the imaging apparatus 50 may capture an image of the processed image in the area indicated by the area display.

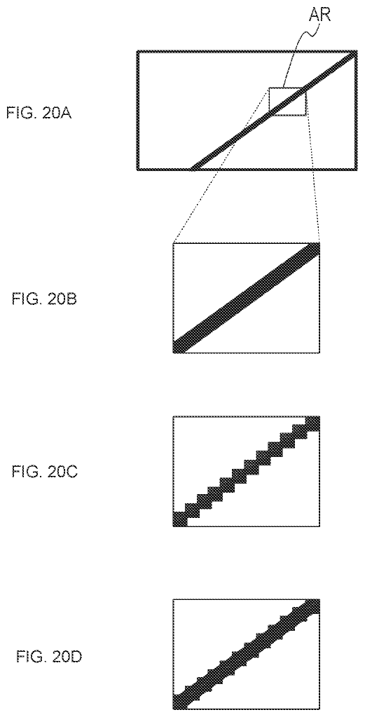

FIG. 20 shows an example of operation to be performed in a case where image quality is evaluated by use of a display image subjected to image processing. A display image is illustrated in (a) of FIG. 20. For example, an area frame AR indicating an evaluation area is shown in the display image. An image of the evaluation area in an evaluation image is illustrated in (b) of FIG. 20. A test image showing the evaluation area is illustrated in (c) of FIG. 20. Furthermore, (d) of FIG. 20 illustrates a processed image obtained as a result of performing image processing on the test image. The image quality evaluation unit 25c evaluates the image quality of (d) of FIG. 20 with respect to (b) of FIG. 20.

Thus, image quality evaluation is performed by use of a captured image obtained as a result of imaging a display image subjected to image processing. As a result, it is possible to set an optimum processing flow in such a way as to achieve an optimum image quality of a processed image displayed, in consideration of how the processed image looks.

Note that the effects described in the present specification are merely illustrative and not restrictive, and additional effects may also be achieved.

### 6. APPLICATION EXAMPLES

The technology according to the present disclosure can be applied to various fields. For example, the technology according to the present disclosure may be implemented as an apparatus to be mounted on any type of mobile object such as an automobile, an electric vehicle, a hybrid electric vehicle, a motorcycle, a bicycle, a personal mobility vehicle, an airplane, a drone, a ship, or a robot. Furthermore, the technology according to the present disclosure may be implemented as an apparatus to be mounted on a device to be used in a production process in a factory or a device to be used in the construction field. Moreover, the technology according to the present disclosure can also be applied to the medical field. It is possible to provide images with good image quality to users by applying the technology according to the present disclosure to such fields.

Furthermore, a series of processes described in the specification can be implemented by hardware, software, or a configuration in which hardware and software are combined. In a case where the processes are implemented by software, a program in which a process sequence has been recorded is executed after being installed in a memory in a computer incorporated in dedicated hardware. Alternatively, the program can be executed after being installed on a general-purpose computer capable of performing various types of processing.

For example, the program can be recorded in a hard disk, a solid state drive (SSD), or a read only memory (ROM) as a recording medium in advance. Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray Disc (BD) (registered trademark), a magnetic disk, or a semiconductor memory card. Such a removable recording medium can be provided as so-called packaged software.

Furthermore, the program may be installed on a computer from a removable recording medium, or may also be transferred through wireless or wired communication from a download site to the computer via a network such as a local area network (LAN) or the Internet. The computer can receive the program transferred in this way and install the program on a recording medium such as a built-in hard disk.

Note that the effects described in the present specification are merely illustrative and not restrictive, and additional effects not described herein may also be achieved. Furthermore, the present technology should not be construed as being limited to the above-described embodiments of the technology. The embodiments of the present technology disclose the present technology in the form of illustration, and it is obvious that those skilled in the art can make modifications or substitutions of the embodiments without departing from the gist of the present technology. That is, in order to judge the gist of the present technology, the claims should be taken into consideration.

Furthermore, the image processing control apparatus of the present technology can also adopt the following configurations.

(1) An image processing control apparatus including:

a processing flow setting unit that sets a processing flow for each set of multiple types of image processing to be performed on an input image, by selecting an image processing apparatus to be used for each of the multiple types of image processing on the basis of results of evaluating image qualities of processed images obtained from a test image processed by a plurality of image processing apparatuses.

(2) The image processing control apparatus according to (1), in which

the test image is an image generated as a result of performing, on an evaluation image, processing that is a reverse of each of the multiple types of image processing, and

the processing flow setting unit selects the image processing apparatus to be used for each of the multiple types of image processing on the basis of the results of evaluating the image qualities of the processed images with respect to the evaluation image.

(3) The image processing control apparatus according to (2), in which

the processing flow setting unit selects an image processing apparatus that produces a best image quality evaluation result for each of the multiple types of image processing.

(4) The image processing control apparatus according to (3), in which

the test image is an image obtained for each image processing apparatus as a result of the processing performed on an evaluation image appropriate to the image processing apparatus.

(5) The image processing control apparatus according to (2), in which

the processing flow setting unit selects a combination of image processing apparatuses producing a best result of evaluating an image quality of an output image from among combinations of respective image processing apparatuses to be used for the multiple types of image processing, the output image being obtained as a result of performing the multiple types of image processing on the input image.

(6) The image processing control apparatus according to (5), in which

the processing flow setting unit performs parameter adjustment for the respective image processing apparatuses to be used for the multiple types of image processing, and sets parameters that produce a best result of evaluating the image quality of the output image, the output image being obtained as a result of performing the multiple types of image processing on the input image.

(7) The image processing control apparatus according to (5) or (6), in which

the test image is an image generated as a result of performing processing on the evaluation image, the processing being a reverse of the multiple types of image processing to be performed on the input image on the basis of the processing flow set in the processing flow setting unit.

(8) The image processing control apparatus according to any one of (2) to (7), further including:

an information storage unit that stores processing orders of the multiple types of image processing, information indicating image processing apparatuses selected for each of the processing orders, and the image quality evaluation results.

(9) The image processing control apparatus according to any one of (2) to (8), further including:

a processing performance management unit that detects an image processing apparatus available for image processing of the input image on the basis of processing performance of the image processing apparatus,

in which the processing flow setting unit selects an image processing apparatus to be used for the image processing from among a plurality of the image processing apparatuses detected in the processing performance management unit.

(10) The image processing control apparatus according to (9), in which

the processing performance management unit detects a change in the image processing apparatuses available for the image processing of the input image, and

in a case where there is a change in the available image processing apparatuses, the processing flow setting unit selects an image processing apparatus to be used for the image processing from among image processing apparatuses available after the change.

(11) The image processing control apparatus according to any one of (2) to (10), in which

the processing flow setting unit changes the processing order of the multiple types of image processing and the selected image processing apparatus according to a user's instruction.

(12) The image processing control apparatus according to (11), further including:

a display unit that displays processing performance of the plurality of image processing apparatuses and the processing flow set in the processing flow setting unit; and

an operation unit that receives the user's instruction issued on the basis of display on the display unit, the operation unit being provided on a display screen of the display unit.

(13) The image processing control apparatus according to any one of (1) to (12), in which

results of evaluating qualitative image qualities and quantitative image qualities or evaluation results obtained by integration of the results of evaluating the qualitative image qualities and the quantitative image qualities are used as the image quality evaluation results.

(14) The image processing control apparatus according to any one of (1) to (13), in which

the image quality evaluation results refer to results of evaluating image qualities of captured images obtained by imaging of the processed images displayed.

In addition, the present technology includes a program as follows.

(1) A program for causing a computer to control image processing using a plurality of image processing apparatuses, the program causing the computer to perform:

a step of setting a processing flow for each set of multiple types of image processing to be performed on an input image by selecting an image processing apparatus to be used for each of the multiple types of image processing on the basis of results of evaluating image qualities of processed images obtained from a test image processed by the plurality of image processing apparatuses.

### REFERENCE SIGNS LIST

10 Image processing system

20, 20a, 20b, 20c Image processing control apparatus

21 Processing performance management unit

22 Information storage unit

23a, 23b Image storage unit

24a, 24b Image processing unit

25a, 25b, 25c Image quality evaluation unit

26a, 26b Processing flow setting unit

27 Display unit

28 Operation unit

30-1 to 30-8 to 30-n, 30-in, 30-out Image processing apparatus

31 Processing performance notification unit

32 Signal processing unit

40 Display apparatus

50 Imaging apparatus

1. An image processing control apparatus comprising:
a processing flow setting unit that sets a processing flow for each set of multiple types of image processing to be performed on an input image, by selecting an image processing apparatus to be used for each of the multiple types of image processing on a basis of results of evaluating image qualities of processed images obtained from a test image processed by a plurality of image processing apparatuses.

2. The image processing control apparatus according to claim 1, wherein
the test image is an image generated as a result of performing, on an evaluation image, processing that is a reverse of each of the multiple types of image processing, and
the processing flow setting unit selects the image processing apparatus to be used for each of the multiple types of image processing on a basis of the results of evaluating the image qualities of the processed images with respect to the evaluation image.

3. The image processing control apparatus according to claim 2, wherein
the processing flow setting unit selects an image processing apparatus that produces a best image quality evaluation result for each of the multiple types of image processing.

4. The image processing control apparatus according to claim 3, wherein
the test image is an image obtained for each image processing apparatus as a result of the processing performed on an evaluation image appropriate to the image processing apparatus.

5. The image processing control apparatus according to claim 2, wherein
the processing flow setting unit selects a combination of image processing apparatuses producing a best result of evaluating an image quality of an output image from among combinations of respective image processing apparatuses to be used for the multiple types of image processing, the output image being obtained as a result of performing the multiple types of image processing on the input image.

6. The image processing control apparatus according to claim 5, wherein
the processing flow setting unit performs parameter adjustment for the respective image processing apparatuses to be used for the multiple types of image processing, and sets parameters that produce a best result of evaluating the image quality of the output image, the output image being obtained as a result of performing the multiple types of image processing on the input image.

7. The image processing control apparatus according to claim 5, wherein
the test image is an image generated as a result of performing processing on the evaluation image, the processing being a reverse of the multiple types of image processing to be performed on the input image on a basis of the processing flow set in the processing flow setting unit.

8. The image processing control apparatus according to claim 2, further comprising:
an information storage unit that stores processing orders of the multiple types of image processing, information indicating image processing apparatuses selected for each of the processing orders, and the image quality evaluation results.

9. The image processing control apparatus according to claim 2, further comprising:
a processing performance management unit that detects an image processing apparatus available for image processing of the input image on a basis of processing performance of the image processing apparatus,
wherein the processing flow setting unit selects an image processing apparatus to be used for the image processing from among a plurality of the image processing apparatuses detected in the processing performance management unit.

10. The image processing control apparatus according to claim 9, wherein
the processing performance management unit detects a change in the image processing apparatuses available for the image processing of the input image, and
in a case where there is a change in the available image processing apparatuses, the processing flow setting unit selects an image processing apparatus to be used for the image processing from among image processing apparatuses available after the change.

11. The image processing control apparatus according to claim 2, wherein
the processing flow setting unit changes the processing order of the multiple types of image processing and the selected image processing apparatus according to a user's instruction.

12. The image processing control apparatus according to claim 11, further comprising:
a display unit that displays processing performance of the plurality of image processing apparatuses and the processing flow set in the processing flow setting unit; and
an operation unit that receives the user's instruction issued on a basis of display on the display unit, the operation unit being provided on a display screen of the display unit.

13. The image processing control apparatus according to claim 1, wherein
results of evaluating qualitative image qualities and quantitative image qualities or evaluation results obtained by integration of the results of evaluating the qualitative image qualities and the quantitative image qualities are used as the image quality evaluation results.

14. The image processing control apparatus according to claim 1, wherein
the image quality evaluation results refer to results of evaluating image qualities of captured images obtained by imaging of the processed images displayed.

15. An image processing control method comprising:
causing a processing flow setting unit to set a processing flow for each set of multiple types of image processing to be performed on an input image by selecting an image processing apparatus to be used for each of the multiple types of image processing on a basis of results of evaluating image qualities of processed images obtained from a test image processed by a plurality of image processing apparatuses.
